(19) United States
(12) Patent Application Publication
(10) Pub. No.: US 2026/0299236 A1
(43) Pub. Date: Oct. 1, 2026

(54) ON-BOARD OPTICAL CONNECTION DEVICE

(71) Applicant: AIP Inc., New Taipei City (TW)

(72) Inventor: Chia Lee, New Taipei City (TW)

(21) Appl. No.: 19/698,960

(22) Filed: Jun. 5, 2026

Related U.S. Application Data
(63) Continuation-in-part of application No. 19/000,859, filed on Dec. 24, 2024.
Application No. 19/000,859 is a continuation-in-part of application No. 18/780,529, filed on Jul. 23, 2024.
(60) Provisional application No. 63/821,666, filed on Jun. 11, 2025.
(60) Provisional application No. 63/712,502, filed on Oct. 27, 2024.
(60) Provisional application No. 63/624,809, filed on Jan. 25, 2024.

(51) Int. Cl. G02B 6/43

(52) U.S. Cl. CPC G02B 6/43

(57) ABSTRACT

An on-board optical connection device includes a first photonic integrated circuit disposed on a first data processing device, a second photonic integrated circuit disposed on a second data processing device, an optical waveguide optically coupled between the first and the second photonic integrated circuits, a middle gap defined between the first data processing device and the second data processing device and positioned under the optical waveguide, and at least a first flexible element disposed on a bottom of the second data processing device below the second photonic integrated circuit. The second photonic integrated circuit and the second data processing device are adjustable in position through the first flexible element.

### CROSS REFERENCE TO RELATED APPLICATIONS

This application claims the benefit of U.S. provisional patent application Ser. No. 63/821,666, filed Jun. 11, 2025, the entirety of which is incorporated by reference herein.

This application is a continuation-in-part of U.S. patent application Ser. No. 19/000,859, filed Dec. 24, 2024, which claims the priority of U.S. provisional patent application Ser. No. 63/712,502, filed Oct. 27, 2024, and '859 application is a continuation-in-part of U.S. patent application Ser. No. 18/780,529, filed Jul. 23, 2024, which claims the priority of U.S. provisional patent application Ser. 63/624,809, filed Jan. 25, 2024, the entireties of which are incorporated by reference herein.

### BACKGROUND OF INVENTION

### FIELD OF INVENTION

The present invention relates to a technical field of optical connectors, and particularly to an on-board optical connection device configured for optical communication between to data processing devices.

### RELATED ART

With the advancement of cloud and AI technologies, high-speed transmission systems with increasingly greater bandwidth will be required in the future. Optoelectronic integrated circuits (OEICs) have been widely used to address the explosive demand for computing speed. OEICs use photons instead of electrons for calculation and data transmission in integrated circuits, bringing great benefits to the development of industries requiring high-performance data exchange, long-distance interconnection, 5G facilities, and computing equipment. OEICs are configured with photonic integrated circuits (PICs) and electronic integrated circuits (EICs) and are generally co-packaged as co-packaged optics (CPO). To integrate multiple processors within a single system has emerged as a key development trend of applications of OEICs. However, there is still no better solution for optical interconnection between multi-processor architectures, not to mention the maintenance of accurate optical alignment throughout packaging processes, thereby improving yield.

### SUMMARY OF INVENTION

An object of the present application is to provide an on-board optical connection device capable of optically interconnecting two data processing devices, while maintaining accurate optical alignment during packaging processes.

To achieve the above-mentioned object, the present application provides an on-board optical connection device, configured for optical communication between a first data processing device and a second data processing device, the on-board optical connection device including a first photonic integrated circuit disposed on the first data processing device, a second photonic integrated circuit disposed on the second data processing device, and an optical waveguide optically coupled between the first photonic integrated circuit and the second photonic integrated circuit. A middle gap is defined between the first data processing device and the second data processing device and is positioned under the optical waveguide. At least a first flexible element disposed on a bottom of the second data processing device below the second photonic integrated circuit. The second photonic integrated circuit and the second data processing device are adjustable in position through the first flexible element.

Optionally, the first data processing device includes a first load board and a first substrate supporting the first load board, the first photonic integrated circuit is positioned on the first load board, the second data processing device comprises a second load board and a second substrate supporting the second load board, and the second photonic integrated circuit is positioned on the second load board. The first flexible element is positioned on a bottom surface of the second substrate.

Optionally, the optical waveguide includes a plurality of light paths, the first photonic integrated circuit comprises a plurality of first optical channels, the second photonic integrated circuit includes a plurality of second optical channels, and the light paths are disposed in optical alignment with the first and second optical channels, respectively, to enable optical communication between the first data processing device and the second data processing device.

Optionally, each of the first photonic integrated circuit and the second photonic integrated circuit is functionally defined into a light input area and a light output area on opposite sides of the optical waveguide, wherein a signal route is defined by the two light input areas, the two light output areas, and the light paths for the optical communication.

Optionally, a plurality of the first flexible elements are spaced apart from each other and disposed on the bottom surface of the second substrate, and a hollow space is defined between the first flexible elements and the second substrate and adjoins the middle gap.

Optionally, the on-board optical connection device further includes a flexible circuit board, one end of the flexible circuit board connected to the second data processing device, and the other end of the flexible circuit board is connected to an external associated device.

Optionally, the first flexible element is made of a rubber-based material.

Optionally, the on-board optical connection device further includes at least a second flexible element disposed below the optical waveguide in the middle gap, and the optical waveguide is adjustable in position through the second flexible element.

Optionally, the on-board optical connection device further includes a middle load board disposed in the middle gap to support the optical waveguide, and the second flexible element is positioned on a bottom surface of the middle load board away from the optical waveguide.

Optionally, the first flexible element and the second flexible element are made of a same material.

Optionally, the on-board optical connection device further includes a bottom board configured to support the first data processing device, the second data processing device, and the first flexible element.

Optionally, opposite ends of the optical waveguide extend to span the middle gap and are mounted on the first load board and the second load board, respectively.

In the present application, the on-board optical connection device is configured to optically interconnect the first and the second data processing devices, and maintain accurate optical alignment during the packaging process of the first photonic integrated circuit, the optical waveguide, and the second photonic integrated circuit through the floating mechanism including the first flexible element and the second flexible element, which also enhances heat dissipation efficiency for both the first and second data processing devices, thereby successfully overcoming the challenges associated with interconnecting multiple conventional data processing devices, while ensuring accurate optical alignment throughout the packaging process, and addressing poor heat dissipation performance.

### BRIEF DESCRIPTION OF DRAWINGS

To describe the technical solutions in the embodiments of the present application, the following briefly introduces the drawings for describing the embodiments. The drawings in the following description show merely some embodiments of the present application, and a person skilled in the art may still derive other drawings from these drawings without creative efforts.

FIG. 1 is a schematic cross-sectional view of an on-board optical connection device in accordance with an embodiment of the present application.

FIG. 2 is an enlarged view of an optical waveguide of the on-board optical connection device shown in FIG. 1.

FIG. 3 is a schematic perspective view illustrating a working principle of the optical waveguide of FIG. 2, a first photonic integrated circuit, and a second photonic integrated circuit in accordance with an embodiment of the present application.

FIG. 4 is a schematic top plan view showing part of an on-board optical connection device electrically connected with an associated device in accordance with an embodiment of the present application.

FIG. 5 is a schematic perspective view of an on-board optical connection device in accordance with an embodiment of the present application.

FIG. 6 is a schematic cross-sectional view of an on-board optical connection device in accordance with an embodiment of the present application.

FIG. 7 is a schematic cross-sectional view of an on-board optical connection device in accordance with an embodiment of the present application.

FIG. 8 is a schematic cross-sectional view of an on-board optical connection device in accordance with an embodiment of the present application.

FIG. 9 is a schematic cross-sectional view of an on-board optical connection device in accordance with an embodiment of the present application.

### DESCRIPTION OF PREFERRED EMBODIMENTS

The following embodiments are referring to the drawings for exemplifying specific implementable embodiments of the present application. Directional terms described by the present application, such as upper, lower, front, back, left, right, inner, outer, side, etc., are only directions by referring to the drawings, and thus the directional terms are used to describe and understand the present application, but the present application is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component or a first section discussed below could be termed a second element, a second component or a second section without departing from the teachings of the present application. In addition, the present application may repeat reference numerals and/or letters in the various examples. This repetition is for the purpose of simplicity and clarity and does not in itself dictate a relationship between the various embodiments and/or configurations discussed.

The present application provides an on-board optical connection device configured for optical communication including electro-optical signal, optoelectronic signal, and all optical transmission between two data processing devices. Above all, the on-board optical connection device is configured to allow positional adjustment during manufacturing and packaging processes. In some embodiments, the two data processing devices may be graphics processing units, central processing units, neural network processing units, etc., and are all installed inside a system housing.

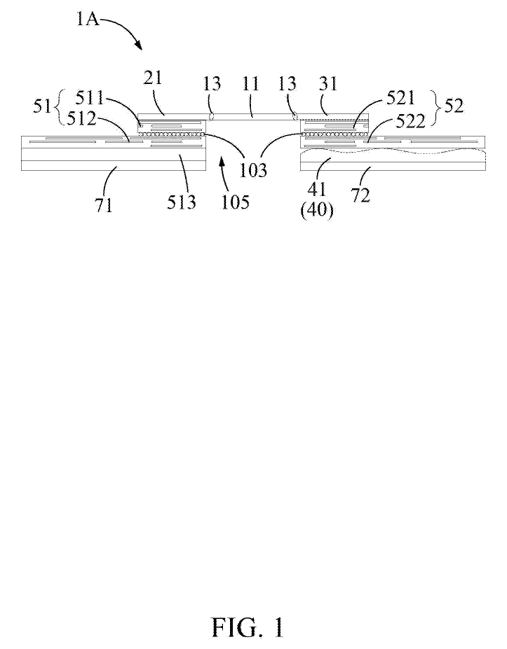

Referring to FIG. 1, which is a schematic cross-sectional view of an on-board optical connection device 1A according to an embodiment of the present application, the on-board optical connection device 1A is configured to optically connect a first data processing device 51 to a second data processing device 52, enabling mutual optical communication therebetween. The on-board optical connection device 1A includes an optical waveguide 11, a first photonic integrated circuit 21 bonded to an end of the optical waveguide 11, a second photonic integrated circuit 31 bonded to another end of the optical waveguide 11, and at least a first flexible element 41 disposed on a bottom of the second data processing device 52 below the second photonic integrated circuit 31. In some embodiments, each of the first photonic integrated circuit 21 and the second photonic integrated circuit 31 is configured with an integrated light source (not shown) for the generation of light signals. For example, the light source may be a light bar equipped with a plurality of laser diodes. In some other embodiments, the first photonic integrated circuit 21 and the second photonic integrated circuit 31 are configured without an integrated light source and instead rely on an external light source to provide the required light for optical signal transmission.

As shown in FIG. 1, in some embodiments, the first data processing device 51 includes a first load board 511 and a first substrate 512 supporting the first load board 511, and the first photonic integrated circuit 21 is positioned on the first load board 511. The second data processing device 52 includes a second load board 521 and a second substrate 522 supporting the second load board 521, and the second photonic integrated circuit 31 is positioned on the second load board 521. In this embodiment, the first load board 511 and the second load board 521 are mounted on the first substrate 512 and the second substrate 522 using flip-chip bonding through electrically conductive elements 103, respectively. Preferably, the electrically conductive elements 103 may be electrically conductive pillars or bumps.

In actual applications, due to certain factors, such as various designs, configurations, manufacturing costs, and limited installation space, the first data processing device 51 and the second data processing device 52 are implemented as separate units and installed individually within the limited internal space of a device housing (not shown). As a result, the first data processing device 51 and the second data processing device 52 need to be interconnected for mutual optical communication. Specifically, as shown in FIG. 1, a middle gap 105 is defined between the first data processing device 51 and the second data processing device 52 and is positioned under the optical waveguide 11. A plurality of bonding elements 13 are applied to the opposite two ends of the optical waveguide 11, so that the optical waveguide 11 is fixedly connected to the first photonic integrated circuit 21 and the second photonic integrated circuit 31, respectively. Preferably, the bonding element 13 is an optical adhesive having a refractive index greater than air. In some embodiments, the bonding element 13 is made of epoxy resin-based material but not limited thereto. In some embodiments, the middle gap 105 may serve as additional space for placement of other components in the system housing (not shown).

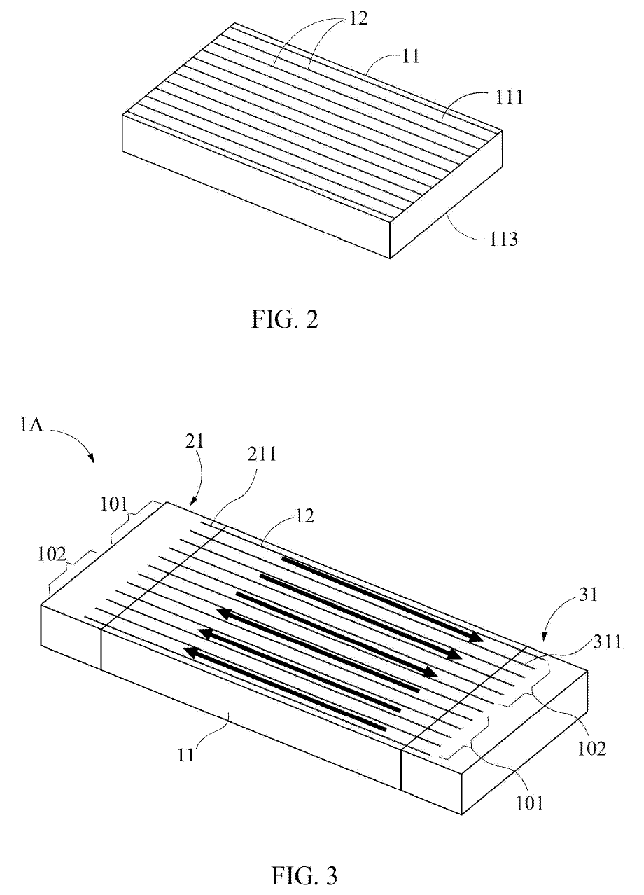

Referring to FIG. 2, which is an enlarged view of the optical waveguide 11 of the on-board optical connection device 1A, the optical waveguide 11 is configured to have a plurality of light paths 12 each extending to opposite ends of the optical waveguide 11. In this embodiment, the light paths 12 are arranged in parallel to each other on an upper surface 111 of the optical waveguide 11 to propagate light beams. In some embodiments, the light paths 12 may be formed in the optical waveguide 11 between the upper surface 111 and a lower surface 113.

Preferably, the optical waveguide 11 is made of a material containing, for example, silica. Alternatively, the optical waveguide 11 may be made of a material containing silicon-on-insulator (SOI), lithium niobate (LiNbO3), or polymers. In some embodiments, the optical waveguide 11 may be formed using a material of such as fused silica, quartz, glass, borosilicate glass, etc. It should be noted that the optical waveguide 11 includes a planar lightwave circuit (PLC). In some embodiments, the planar lightwave circuit may be configured in various ways, including, but not limited to, a straight-line circuit, a splitter circuit, an arrayed waveguide grating wavelength multiplexer, and a cross connect-type circuit.

Referring to FIG. 3, it is a schematic perspective view illustrating a working principle of the optical waveguide 11, the first photonic integrated circuit 21, and the second photonic integrated circuit 31. In some embodiments, each of the first photonic integrated circuit 21 and the second photonic integrated circuit 31 is functionally classified into a light input area 101 and a light output area 102 on opposite sides of the optical waveguide 11. In some embodiments, the first photonic integrated circuit 21 includes a plurality of first optical channels 211, and the second photonic integrated circuit 31 includes a plurality of second optical channels 311. It is noted that certain components are not shown in FIG. 3 for clarity of presentation of the light input areas 101 and the light output areas 102. As shown in FIG. 3, the light paths 12 are disposed in optical alignment with the first optical channels 211 and the second optical channels 311, respectively, to enable optical signal transmission between the first data processing device and the second data processing device.

Still referring to FIG. 3, an optical signal is transmitted from the light input area 101 on the side of the first photonic integrated circuit 21, through the light paths 12 of the optical waveguide 11, to the light output area 102 on the side of second photonic integrated circuit 31, thereby forming a first signal path (as indicated by the arrow pointing to the second photonic integrated circuit 31). Likewise, another optical signal is transmitted from the light input area 101 on the side of the second photonic integrated circuit 31, through the light paths 12 of the optical waveguide 11 in a direction opposite to the first signal path, to the light output area 102 on the side of the first photonic integrated circuit 21, thereby forming a second signal path (as indicated by the arrow pointing to the first photonic integrated circuit 21). That is, the first signal path and the second signal path covering the two light input areas 101 and the two light output areas 102 on opposite sides of the optical waveguide 11 form a signal transmission route, which is conducive to the area reduction in terms of the arrangement of the first data processing device 51 and the second data processing device 52, thereby achieving all optical transmission between the first data processing device 51 and the second data processing device 52 of the on-board optical connection device 1A.

Referring to FIG. 1, the on-board optical connection device 1A further features a floating mechanism 40 including the first flexible element 41. It should be noted that the shape and size of the first flexible element 41 shown in FIG. 1 are merely illustrative of its presence and position and are not intended to be limiting. In some embodiments, the first flexible element 41 is made of a rubber-based material or other flexible material that permits slight displacement or floating of the second data processing device 52, the second photonic integrated circuit 31, and the optical waveguide 11 with respect to the second support board 72. In this embodiment, the first flexible element 41 is disposed below a bottom surface of the second substrate 522, and a fixing member 513 is disposed to fix the first data processing device 51. In some embodiments, the fixing member 513 may be a solder ball, a screw element, or a bolt element for fixed connection. Preferably, a first support board 71 is provided to support the first data processing device 51, and a second support board 72 is provided to support the second data processing device 52.

As shown in FIG. 1, the first flexible element 41 is disposed between the second substrate 522 and the second support board 72. During a process of packaging the first and the second photonic integrated circuits 21 and 31 on the first and the second data processing devices 51 and 52, optical alignment positions may shift due to temperature cycles, such as thermal expansion and contraction affecting the materials of the aforementioned components, or owing to assembly forces applied thereon. To address the above issue, the first flexible element 41 allows positional adjustment of the second photonic integrated circuit 31 and the second data processing device 52 through the first flexible element 41. In other words, the first flexible element 41 is configured to floatingly support the second substrate 522, the second load board 521, and the second photonic integrated circuit 31, thereby ensuring accurate optical alignment among the second photonic integrated circuit 31, the optical waveguide 11, the first photonic integrated circuit 21 during the packaging process.

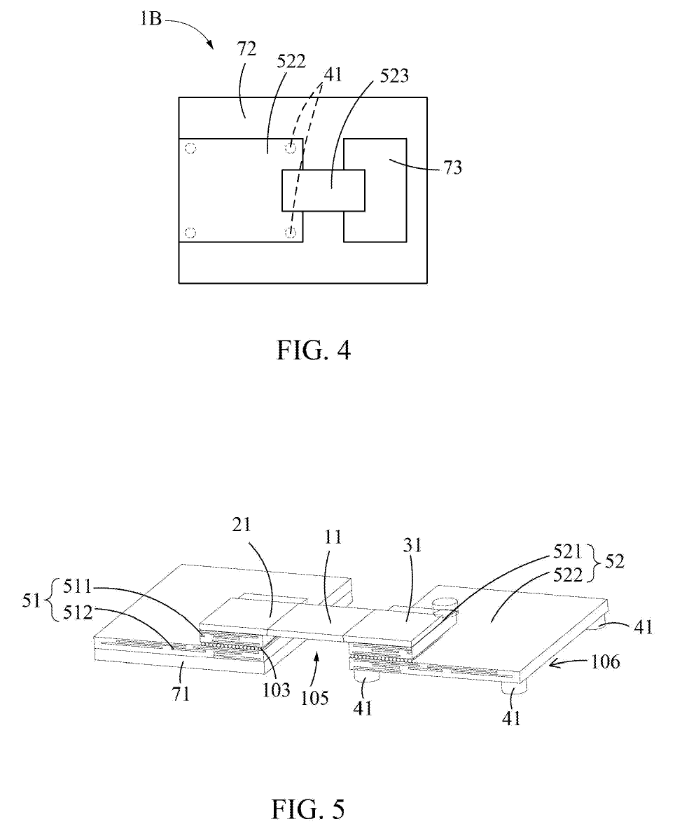

Referring to FIGS. 4 and 5, FIG. 4 is a schematic top plan view showing part of an on-board optical connection device 1B, and FIG. 5 is a schematic perspective view of the on-board optical connection device 1B in accordance with an embodiment of the present application. The on-board optical connection device 1B is mainly different from the above-mentioned embodiments in the configuration of the first flexible element 41. Apart from the differences described above, the on-board optical connection device 1B shares the same structural components as the on-board optical connection device 1A. Therefore, repetitive descriptions are not provided, and the first and the second photonic integrated circuits 21 and 31 and the optical waveguide 11 are omitted in FIG. 4 for clarity. As shown in FIG. 4, a plurality of the first flexible elements 41 are spaced apart from each other and disposed on corners of the bottom surface of the second substrate 522. The separate arrangement of the first flexible elements 41 not only allows positional adjustment of the second photonic integrated circuit 31 and the second data processing device 52 through the first flexible elements 41 but also reduces the production cost of the first flexible elements 41. In some embodiments, each of the first flexible elements 41 may be strip-like in shape at peripheries of the bottom of the second substrate 522, or pad-like in shape, which is not limited here.

Still referring to FIG. 4, in some embodiments, the on-board optical connection device 1B further includes a flexible circuit board 523 electrically connected to an associated device 73. One end of the flexible circuit board 523 is connected to the second substrate 522, and the other end of the flexible circuit board 523 is connected to the associated device 73, thereby enabling electrical signal transmission between the second data processing device 52 and the associated device 73.

As shown in FIG. 5, a hollow space 106 is formed between the first flexible elements 41 and the second substrate 522 and adjoins the middle gap 105. The hollow space 106 serves as air flow channel to facilitate heat dissipation for the second data processing device 52, thereby improving stability of the optical signal transmission.

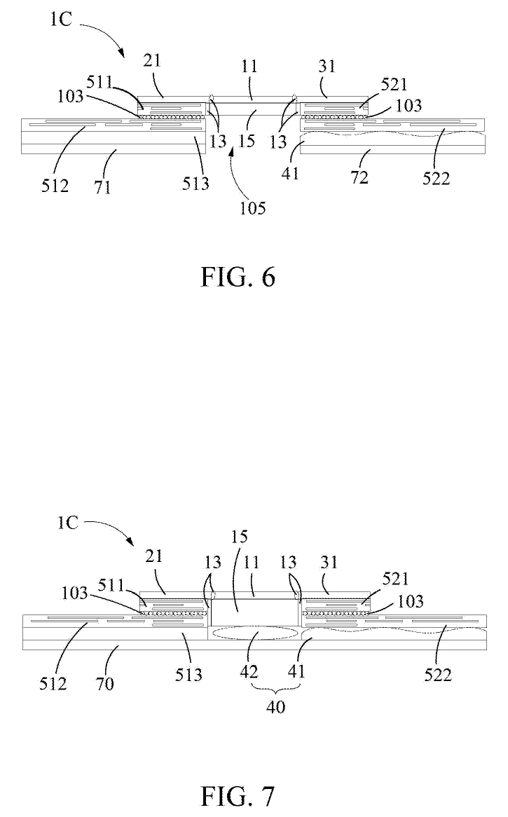

Referring to FIG. 6 illustrating a schematic cross-sectional view of an on-board optical connection device 1C in accordance with an embodiment of the present application, the on-board optical connection device 1C shares the same structural components as the on-board optical connection device 1A except for several additional components described in detail below. Therefore, repetitive descriptions of the same structures are not provided. As shown in FIG. 6, a middle load board 15 is disposed in the middle gap 105 to support the optical waveguide 11, and opposite ends of the middle load board 15 are bonded to the first data processing device 51 and the second data processing device 52 through the bonding elements 13, thereby improving the structural strength of the optical waveguide 11 and preventing the occurrence of warpage and bending of the optical waveguide 11 due to a large span between the first load board 511 and the second load board 521.

Referring to FIG. 7, showing a schematic cross-sectional view of the on-board optical connection device 1C in accordance with an embodiment of the present application, a second flexible element 42 is disposed below the optical waveguide 11 in the middle gap 105 and is positioned on a bottom surface of the middle load board 15 away from the optical waveguide 11. It should be noted that the shape and size of the second flexible element 42 shown in FIG. 7 is merely illustrative of its presence and position and is not intended to be limiting. In some embodiments, the second flexible element 42 is made of the same material as the first flexible element 41 and forms the floating mechanism 40 with the first flexible element 41. Similarly, the optical waveguide 11 is adjustable in position through the second flexible element 42.

As shown in FIG. 7, a bottom board 70 is provided in replacement of the first support board 71 and the second support board 72. The bottom board 70 is mounted in the system housing to support the first data processing device 51, the optical waveguide 11, and the second data processing device 52. The second flexible element 42 is disposed between the bottom board 70 and the middle load board 15 to floatingly support the middle load board 15 and the optical waveguide 11, thereby ensuring accurate optical alignment among the first photonic integrated circuit 21, the optical waveguide 11, and the second photonic integrated circuit 31 during the packaging process.

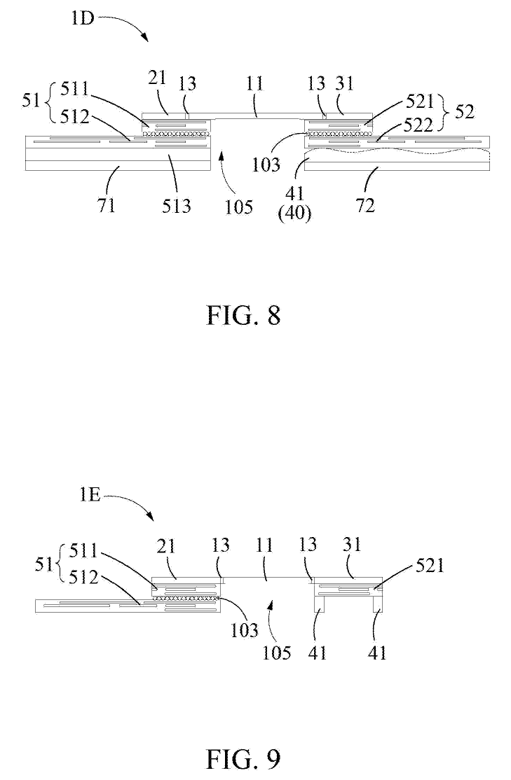

Referring to FIG. 8, showing a schematic cross-sectional view of an on-board optical connection device 1D in accordance with an embodiment of the present application, in this embodiment, opposite ends of the optical waveguide 11 extend to span the middle gap 105 and are mounted on the first load board 511 and the second load board 521, respectively, thereby enhancing bonding strength.

Referring to FIG. 9, showing a schematic cross-sectional view of an on-board optical connection device 1E in accordance with an embodiment of the present application, in this embodiment, the second data processing device 52 is configured without the second substrate 522, and instead relies on the first flexible elements 41 to support the second photonic integrated circuit 31 and the second load board 521. Specifically, the first flexible elements 41 are disposed on a bottom surface of the second load board 521 and allows positional adjustment of the second photonic integrated circuit 31 and the second load board 521 through the first flexible elements 41.

The present application provides the on-board optical connection device to optically interconnect the first and the second data processing devices, and maintain accurate optical alignment during the packaging process of the first photonic integrated circuit, the optical waveguide, and the second photonic integrated circuit through the floating mechanism including the first flexible element and the second flexible element. In addition, the implementation of the floating mechanism enhances heat dissipation efficiency for both the first and second data processing devices. Accordingly, the on-board optical connection device of the present application successfully overcomes the challenges associated with interconnecting multiple conventional data processing devices, while ensuring accurate optical alignment throughout the packaging process, and addressing poor heat dissipation performance.

While the application has been disclosed in conjunction with a description of certain embodiments, including those that are currently believed to be the preferred embodiments, the detailed description is intended to be illustrative and should not be understood to limit the scope of the present application. As would be understood by one of ordinary skill in the art, embodiments other than those described in detail herein are encompassed by the present application. Modifications and variations of the described embodiments may be made without departing from the scope of the application.

What is claimed is:

1. An on-board optical connection device, configured for optical communication between a first data processing device and a second data processing device, the on-board optical connection device comprising:
a first photonic integrated circuit disposed on the first data processing device;
a second photonic integrated circuit disposed on the second data processing device;
an optical waveguide optically coupled between the first photonic integrated circuit and the second photonic integrated circuit, wherein a middle gap is defined between the first data processing device and the second data processing device and is positioned under the optical waveguide; and
at least a first flexible element disposed on a bottom of the second data processing device below the second photonic integrated circuit, wherein the second photonic integrated circuit and the second data processing device are adjustable in position through the first flexible element.

2. The on-board optical connection device of claim 1, wherein the first data processing device comprises a first load board and a first substrate supporting the first load board, the first photonic integrated circuit is positioned on the first load board, the second data processing device comprises a second load board and a second substrate supporting the second load board, and the second photonic integrated circuit is positioned on the second load board, wherein the first flexible element is positioned on a bottom surface of the second substrate.

3. The on-board optical connection device of claim 1, wherein the optical waveguide comprises a plurality of light paths, the first photonic integrated circuit comprises a plurality of first optical channels, the second photonic integrated circuit comprises a plurality of second optical channels, and the light paths are disposed in optical alignment with the first and the second optical channels, respectively, to enable optical communication between the first data processing device and the second data processing device.

4. The on-board optical connection device of claim 3, wherein each of the first photonic integrated circuit and the second photonic integrated circuit is functionally defined into a light input area and a light output area on opposite sides of the optical waveguide, wherein a signal route is defined by the two light input areas, the two light output areas, and the light paths for the optical communication.

5. The on-board optical connection device of claim 2, wherein a plurality of the first flexible elements are spaced apart from each other and disposed on the bottom surface of the second substrate, and a hollow space is defined between the first flexible elements and the second substrate and adjoins the middle gap.

6. The on-board optical connection device of claim 2, wherein opposite ends of the optical waveguide extend to span the middle gap and are mounted on the first load board and the second load board, respectively.

7. The on-board optical connection device of claim 1, further comprising a flexible circuit board, one end of the flexible circuit board connected to the second data processing device, and the other end of the flexible circuit board is connected to an external associated device.

8. The on-board optical connection device of claim 1, wherein the first flexible element is made of a rubber-based material.

9. The on-board optical connection device of claim 1, further comprising at least a second flexible element disposed below the optical waveguide in the middle gap, wherein the optical waveguide is adjustable in position through the second flexible element.

10. The on-board optical connection device of claim 9, further comprising a middle load board disposed in the middle gap to support the optical waveguide, and the second flexible element is positioned on a bottom surface of the middle load board away from the optical waveguide.

11. The on-board optical connection device of claim 9, wherein the first flexible element and the second flexible element are made of a same material.

12. The on-board optical connection device of claim 1, further comprising a bottom board configured to support the first data processing device, the second data processing device, and the first flexible element.
